(19) United States
(12) Patent Application Publication
(10) Pub. No.: US 2014/0033839 A1
(43) Pub. Date: Feb. 6, 2014

(54) ADJUSTING APPARATUS FOR RELEASE MEMBER

(71) Applicants: YUN-LUNG CHEN, Tu-Cheng (TW); CHUNG CHAI, Tu-Cheng (TW); DA-LONG SUN, Wuhan City (CN); LI TONG, Wuhan City (CN); GANG CHENG, Wuhan City (CN)

(72) Inventors: YUN-LUNG CHEN, Tu-Cheng (TW); CHUNG CHAI, Tu-Cheng (TW); DA-LONG SUN, Wuhan City (CN); LI TONG, Wuhan City (CN); GANG CHENG, Wuhan City (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/595,359

(22) Filed: Aug. 27, 2012

(30) Foreign Application Priority Data
Aug. 6, 2012 (CN) 2012102767752

(51) Int. Cl. F16H 21/50; B65D 83/00

(52) U.S. Cl. 74/25

(57) ABSTRACT

An adjusting apparatus includes a driver, a transmission shaft attached to the driver, and a drive shaft detachably attached to the transmission shaft. A release member is secured to the drive shaft. The transmission shaft is rotated by the driver to rotate the drive shaft and the release member together, and the release member is rotated to move merchandise that is attached to the release member.

### BACKGROUND

1. Technical Field

The present disclosure relates to electronic devices, more particularly to an adjusting apparatus for a release member of a delivery tray in a vending machine.

2. Description of Related Art

Vending machines allow customers to buy merchandise, such as water, tissues or assorted snacks, for example, twenty fours a day. The vending machine includes a delivery tray, and the delivery tray includes a plurality of separated plates. A plurality of passages is defined between the separated plates, for the merchandise to pass through. A release member is often located in each of the plurality of passages. When the customer retrieves the merchandise from the vending machine, a driver moves the release member to push the merchandise out of the passage. To ensure the merchandise drops to a suitable location, an original position of the release member needs to be adjusted. However, when adjusting the original position of the release member, the release member, the driver, the plurality of separated plates all need to be detached from the delivery tray, which is inconvenient. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an adjusting apparatus and a delivery tray in accordance with an embodiment.

FIG. 2 is an exploded, isometric view of the adjusting apparatus and a side plate of the delivery tray of FIG. 1.

FIG. 3 is an exploded, isometric view of a mounting box, a driver, a transmission shaft and a system command returning module of FIG. 2.

FIG. 4 is an assembled view of FIG. 3.

FIG. 5 is an assembled view of FIG. 1.

FIG. 6 is an assembled view of FIG. 2, but without a release member and a clipping member.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

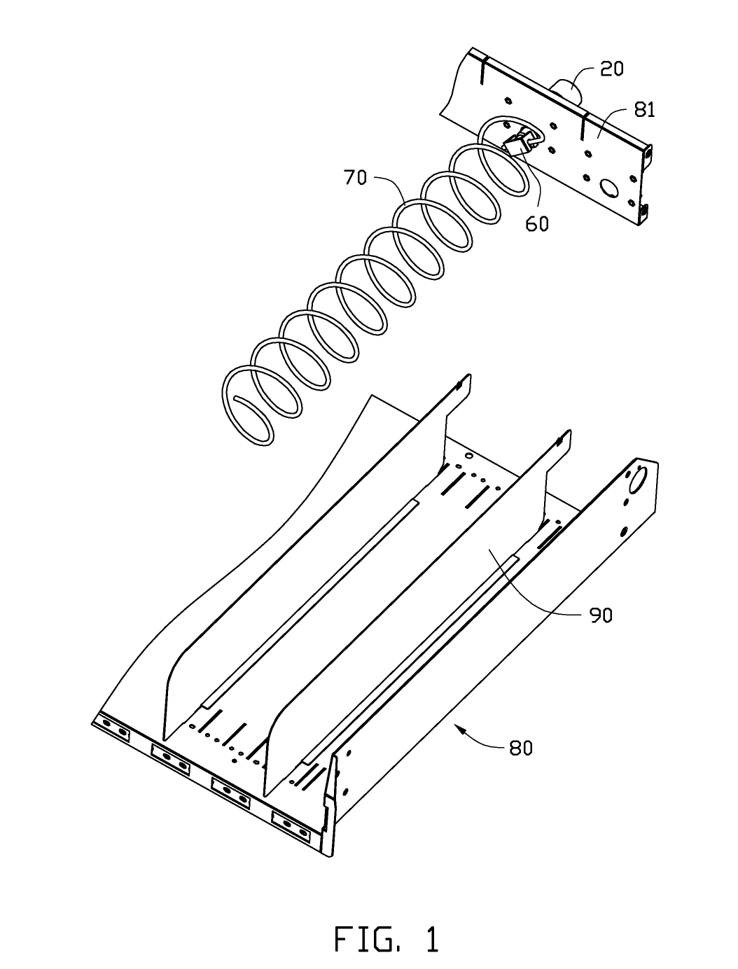

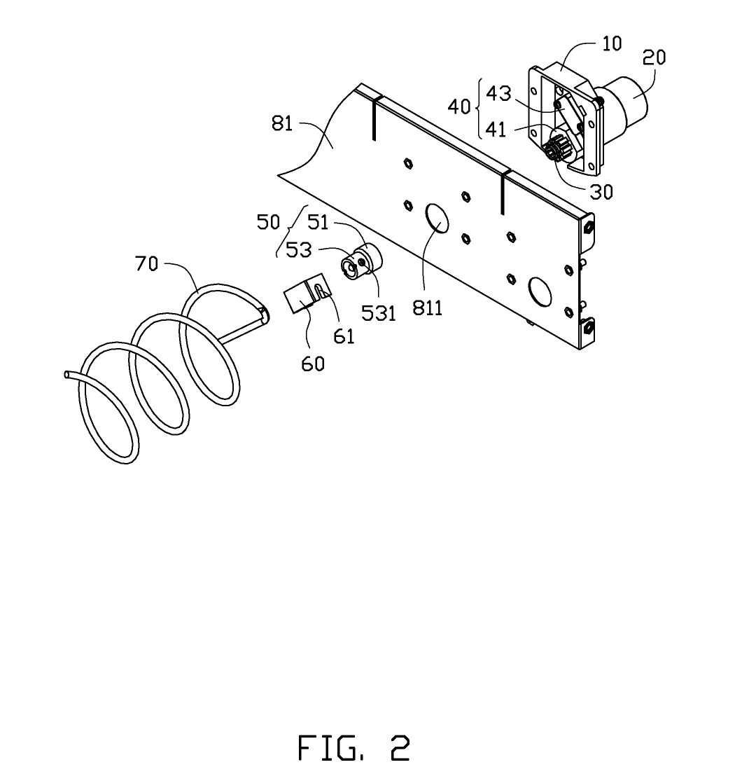

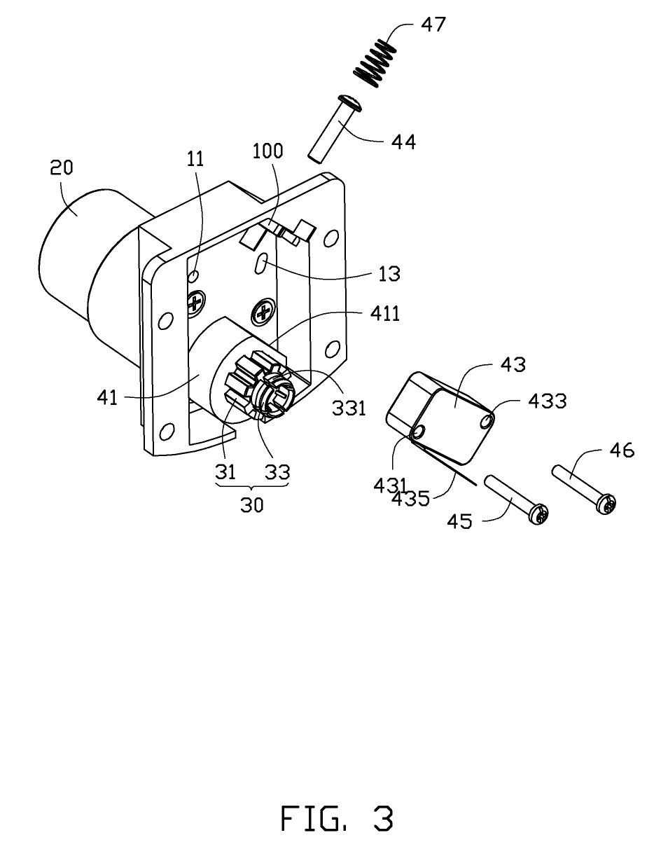

FIGS. 1-3 illustrate an adjusting apparatus and a delivery tray 80 of a vending machine (not shown) in accordance with an embodiment. The adjusting apparatus includes a mounting box 10, a driver 20 secured to the mounting box 10, a transmission shaft 30, a system command returning module 40, a drive shaft 50, and a clipping member 60. In one embodiment, the driver 20 is a motor, and the drive shaft 50 is detachably secured to the transmission shaft 30 by meshing.

The mounting box 10 defines a mounting hole 11 and a sliding slot 13 adjacent to the mounting hole 11. The transmission shaft 30 includes a connecting portion 31 and an engaging portion 33 extending from the connecting portion 31. A clipping slot 331 is defined in the engaging portion 33.

The system command returning module 40 includes a touching block 41 secured to the connecting portion 31, a sensor switch 43 engaged with the touching block 41, and a resisting member 44 engaged with the sensor switch 43. The touching block 41 includes a touching surface 411 and an arcuate surface 413 connected to the touching surface 411. The sensor switch 43 defines a first receiving hole 431 and a second receiving hole 433. In one embodiment, the sensor switch 43 is a rectangle, and the first receiving hole 431 and the second receiving hole 433 are arranged at a diagonal line of the rectangle. A sensor portion 435 is secured to the sensor switch 43, for engaging with the touching surface 411. A resilient member 47 surrounds on the resisting member 44.

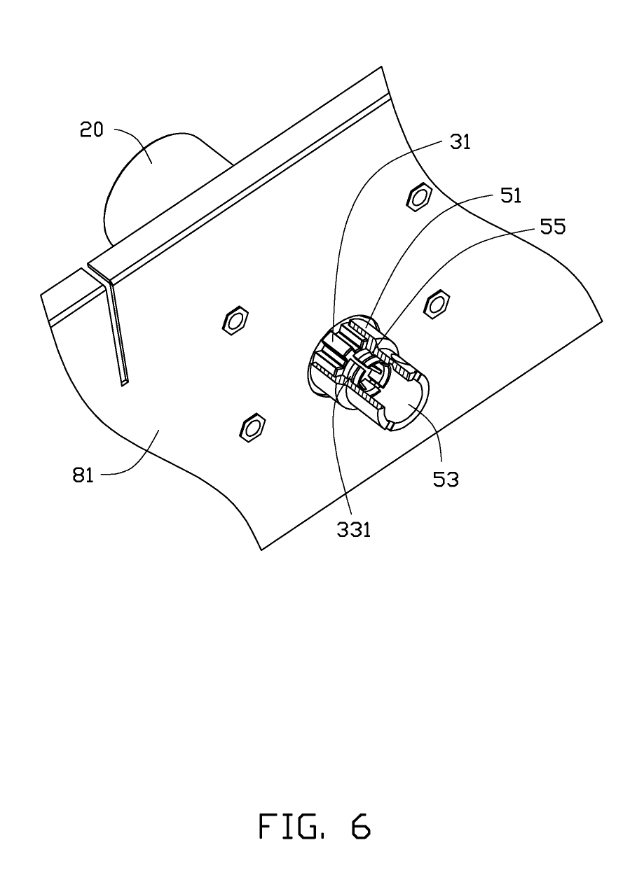

The drive shaft 50 includes a sleeved portion 51 and a securing portion 53 connected to the sleeved portion 51. A clamping portion 55(see FIG. 6), corresponding to the clipping slot 331, is located on a connecting portion connected to the sleeved portion 51 and the securing portion 53. A securing hole 531 is defined in the securing portion 53.

The clipping member 60 is used to secure a release member 70, and a receiving slot 61 is defined in the clipping member 60. In one embodiment, the clipping member 60 is substantially U-shaped, and the release member 70 is a spring.

The delivery tray 80 includes a side plate 81 and a plurality of separated plates 90. A through hole 811 is defined in the side plate 81.

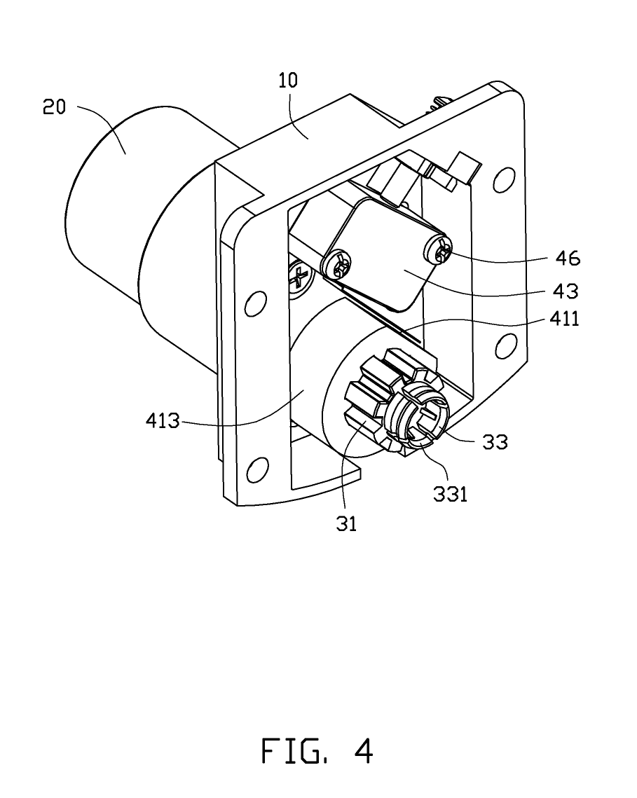

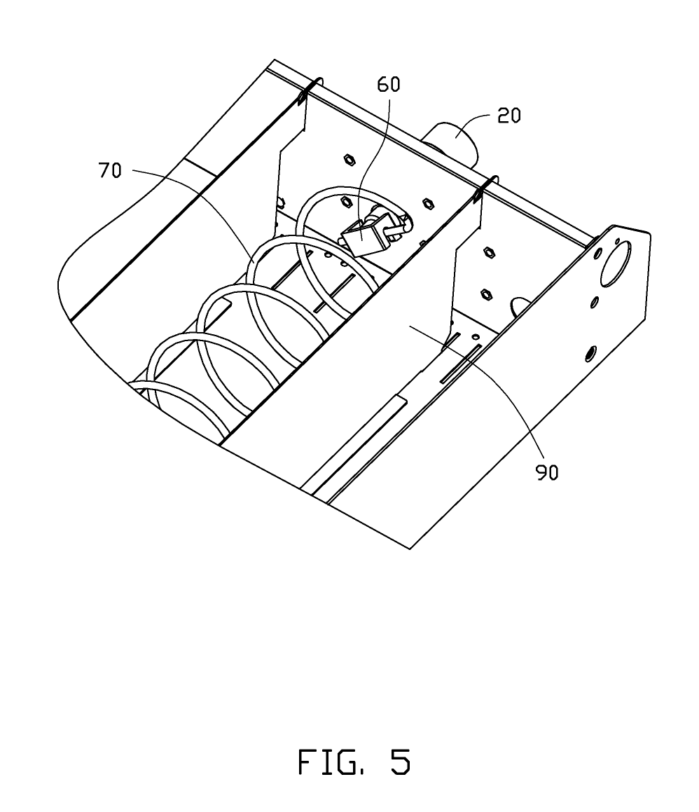

FIGS. 4-6, illustrate an assembly of the adjusting apparatus and the delivery tray in accordance with an embodiment. In assembly, a first shaft 45 is engaged in the first receiving hole 431 and the mounting hole 11, to rotatably secure the sensor switch 43 to the mounting box 10. A second shaft 46 extends through the second receiving hole 433 and is slidably received in the sliding slot 13. The resilient member 47 surrounds on the resisting member 44. The resisting member 44 is slanted relative to the mounting box 10 and extends through the mounting box 10, to abut the sensor switch 43. A fixing member 100 is engaged with the resisting member 44 to prevent the resisting member 44 from disengaging from the mounting box 10. A first end of the resilient member 47 is secured to the mounting box 10. A second end of the resilient member 47 is secured to a head of the resisting member 44. Therefore, the system command returning module 40 is secured to the mounting box 10.

The mounting box 10 is located outside of the side plate 81, and the transmission shaft 30 extends through the through hole 811. The mounting box 10 is secured to the side plate 81 by means well known in the art, such as screws. The clipping member 60 is placed on the drive shaft 50, and the receiving slot 61 is aligned with the securing hole 531. The release member 70 is located between two of the plurality of separated plates 90. An end of the release member 70 extends through the receiving slot 61 and the securing hole 531, to secure the release member 70 to the drive shaft 50 and the clipping member 60. The drive shaft 50 is moved towards the transmission shaft 30, and the clamping portion 55 is clipped in the clipping slot 331. Thus, the drive shaft 50 is secured to the transmission shaft 30.

In use, a circle rotated command from a system of the vending machine, is sent to the driver 20. The driver 20 starts to work to rotate the transmission shaft 30. The transmission shaft 30 rotates the drive shaft 50 and the release member 70, so that the release member 70 push merchandise to disengage from the delivery tray 80. When the transmission shaft 30 is rotated and the arcuate surface 413 abut the sensor portion 435, the sensor switch 43 is rotated about the first shaft 45 in a first direction, and the second shaft 46 is slid in the sliding slot 13. Simultaneously, the sensor switch 43 urges the resisting member 44 to deform the resilient member 47. When the arcuate surface 413 passes through the sensor switch 43 and the touching surface 411 abuts the sensor portion 435, the sensor switch 43 is rotated about the first shaft 45 in a second direction opposite to the first direction. The second shaft 46 is slid in the sliding slot 13. The resilient member 47 is released. The sensor portion 435 senses the transmission shaft 30 has been rotated in a circle and can send a signal to the system of the vending machine.

When an original position of the release member 70 needs to be adjusted, the drive shaft 50 is moved to disengage the clamping portion 55 from the clipping slot 331. Thus, the drive shaft 50 can be detached from the transmission shaft 30.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An adjusting apparatus comprising:
a driver;
a transmission shaft attached to the driver; and
a drive shaft detachably attached to the transmission shaft; and a release member secured to the drive shaft;
wherein the transmission shaft with the drive shaft and the release member are rotated by the driver together, and the release member is configured to push out a merchandise retained therein.

2. The adjusting apparatus of claim 1, wherein the transmission shaft defines a clipping slot, the drive shaft comprises a clamping portion, and the clamping portion is engaged in the clipping slot.

3. The adjusting apparatus of claim 2, wherein the transmission shaft comprises a connecting portion and an engaging portion extending from the connecting portion, and the clipping slot is defined in the engaging portion.

4. The adjusting apparatus of claim 3, wherein the drive shaft comprises a sleeved portion attached to the connecting portion and a securing portion extending from the sleeved portion, and the securing portion defines a securing hole for securing the release member.

5. The adjusting apparatus of claim 4, wherein the clamping portion is located between the sleeved portion and the securing portion.

6. The adjusting apparatus of claim 5, further comprising a clipping member attached to the securing portion, a receiving slot is defined in the clipping member, and the receiving slot is aligned with the securing hole to receive the release member.

7. The adjusting apparatus of claim 1, further comprising a touching block and a sensor switch, the touching block is secured to the transmission shaft and comprises a touching surface to engage with the touching block.

8. The adjusting apparatus of claim 7, further comprising a mounting box for securing to a delivery tray, wherein the driver is attached to the mounting box, and the sensor switch is moveably secured to the mounting box.

9. The adjusting apparatus of claim 8, wherein the mounting box defines a sliding slot; the sensor switch comprises a first shaft and a second shaft; the second shaft is slidably received in the second shaft; the sensor switch is rotatably secured to the mounting box by the first shaft; and the transmission shaft rotates the sensor switch about the first shaft, so that the second shaft is slidable in the sliding slot.

10. An adjusting apparatus comprising:
a side plate;
a driver secured to the side plate and located outside of the side plate;
a transmission shaft attached to the driver and extending through the side plate; and
a drive shaft detachably attached to the transmission shaft and located inside of the side plate; and a release member secured to the drive shaft;
wherein the transmission shaft with the drive shaft and the release member are rotated by the driver together, and the release member is configured to push out a merchandise retained therein.

11. The adjusting apparatus of claim 10, wherein the side plate defines a through hole, and the transmission shaft extends through hole.

12. The adjusting apparatus of claim 10, wherein the transmission shaft defines a clipping slot, the drive shaft comprises a clamping portion, and the clamping portion is engaged in the clipping slot.

13. The adjusting apparatus of claim 12, wherein the transmission shaft comprises a connecting portion and an engaging portion extending from the connecting portion, and the clipping slot is defined in the engaging portion.

14. The adjusting apparatus of claim 13, wherein the drive shaft comprises a sleeved portion attached to the connecting portion and a securing portion extending from the sleeved portion, and the securing portion defines a securing hole for securing the release member.

15. The adjusting apparatus of claim 14, wherein the clamping portion is located between the sleeved portion and the securing portion.

16. The adjusting apparatus of claim 15, further comprising a clipping member attached to the securing portion, a receiving slot is defined in the clipping member, and the receiving slot is aligned with the securing hole to receive the release member.

17. The adjusting apparatus of claim 10, further comprising a touching block and a sensor switch, the touching block is secured to the transmission shaft and comprises a touching surface to engage with the touching block.

18. The adjusting apparatus of claim 17, wherein the sensor switch further comprises a sensor portion, and the sensor portion is attached to the touching surface.

19. The adjusting apparatus of claim 17, further comprising a mounting box secured to the side plate and located outside of the side plate; wherein the driver is attached to the mounting box, and the sensor switch is moveably secured to the mounting box.

20. The adjusting apparatus of claim 19, wherein the mounting box defines a sliding slot; the sensor switch comprises a first shaft and a second shaft; the second shaft is slidably received in the second shaft, the sensor switch is rotatably secured to the mounting box by the first shaft; and the transmission shaft rotates the sensor switch about the first shaft, so that the second shaft is slidable in the sliding slot.
